(19) United States
(12) Patent Application Publication
(10) Pub. No.: US 2010/0303377 A1
(43) Pub. Date: Dec. 2, 2010

(54) IMAGE PROCESSING APPARATUS, IMAGE PROCESSING METHOD AND COMPUTER READABLE MEDIUM

(75) Inventors: Takashi MAEDA, Nishitokyo-Shi (JP); Masaru SAKAI, Tokyo-To (JP)

Correspondence Address: SUGHRUE MION, PLLC, 2100 PENNSYLVANIA AVENUE, N.W., SUITE 800, WASHINGTON, DC, 20037, US

(73) Assignee: REGULUS. CO., LTD, Tokyo-to (JP)

(21) Appl. No.: 12/768,454

(22) Filed: Apr. 27, 2010

(30) Foreign Application Priority Data
Apr. 28, 2009 (JP) 2009-109652

(51) Int. Cl. G06K 9/40

(52) U.S. Cl. 382/264; 382/274; 382/266

(57) ABSTRACT

An image processing apparatus includes a characteristic value calculator configured to calculate characteristic values of input pixels based on an input pixel signal and a tone controller configured to perform a tone control independently by each of the input pixels using control parameters corresponding to brightness of a peripheral pixel in vicinity of the corresponding input pixel based on each of the characteristic values calculated by the characteristic value calculator.

### CROSS-REFERENCE TO RELATED APPLICATION

This application is based upon and claims the benefit of priority from the prior Japanese Patent Application No. 2009-109652, filed on Apr. 28, 2009; the entire contents of which are incorporated herein by reference.

### BACKGROUND OF THE INVENTION

The present invention relates to an image processing apparatus, an image processing method and a computer readable medium, in particular, relates to an image processing apparatus, an image processing method and a computer readable medium comprising a program for controlling brightness on image data.

A conventional image processing apparatus to perform a tone control for controlling brightness distribution of image data has been known (see Japanese Patent Application Laid-open No. 2006-81037). Such an image processing apparatus is applied to a developing system for imaging elements, a video signal processing system and the like used for a device such as a digital camera.

However, the conventional image processing apparatus is configured to perform the tone control appropriately in accordance with a shot scene on image data generated by the digital camera. Consequently, as illustrated in FIG. 1, when the tone control is performed in such a manner that a low brightness pixel, e.g. a part being less prone to receiving light, is brightened, tone at a high brightness pixel, e.g. a part receiving light of a strong light source, is compressed due to tone expanding of the low brightness pixel. Therefore, contrast of the high brightness pixel is lowered. On the other hand, when the tone control is performed in such a manner that the high brightness pixel is darkened, the tone of the low brightness pixel is compressed due to the tone expanding of the high brightness pixel. Therefore, contrast of the low brightness pixel is lowered.

Specifically, when the tone control is performed in such a manner that the brightness is matched to the brightness of the high brightness pixel or the low brightness pixel, contrast of a part having brightness level except for the matched brightness level is lowered. In particular, in a case that low brightness distribution and high brightness distribution strikingly appear as, e.g. in a backlight scene, the contrast is extremely lowered.

### BRIEF SUMMARY OF THE INVENTION

According to a first aspect of the present invention, there is provided an image processing apparatus comprising:

a characteristic value calculator configured to calculate characteristic values of input pixels based on an input pixel signal; and

a tone controller configured to perform a tone control independently by each of the input pixels using control parameters corresponding to brightness of a peripheral pixel in vicinity of the corresponding input pixel based on each of the characteristic values calculated by the characteristic value calculator.

In the first aspect, preferably, the characteristic value calculator comprises:

a first low-pass filter configured to remove a first high-frequency component from the input pixel signal to generate a first pixel signal;

a second low-pass filter configured to remove a second high-frequency component from the input pixel signal to generate a second pixel signal; and

a subtractor configured to calculate a difference between the first pixel signal generated by the first low-pass filter and the second pixel signal generated by the second low-pass filter as an edge value.

In the first aspect, preferably, the second low-pass filter removes the second high-frequency component in such a manner that the edge value of each of the input pixels is held.

In the first aspect, preferably, the characteristic value calculator further comprises a converter configured to convert the edge value calculated by the subtractor into a contrast value by clipping the edge value.

In the first aspect, preferably, further comprising an input part configured to input various parameters, wherein

the tone controller performs the tone control based on the inputted various parameters, the contrast value converted by the converter, and the input pixel signal.

In the first aspect, preferably, the tone controller generates a tone curve by applying a sigmoid function to the control parameters and performs the tone control using the tone curve.

According to a second aspect of the present invention, there is provided an image processing method comprising:

calculating characteristic values of input pixels based on an input pixel signal; and

performing a tone control independently by each of the input pixels using control parameters corresponding to brightness of a peripheral pixel in vicinity of the corresponding input pixel based on each of the characteristic values.

In the second aspect, preferably, in calculating the characteristic values,

a first high-frequency component is removed from the input pixel signal to generate a first pixel signal,

a second high-frequency component is removed from the input pixel signal to generate a second pixel signal, and

a difference between the first pixel signal and the second pixel signal is calculated as an edge value.

In the second aspect, preferably, in removing the second high-frequency component, the second high-frequency component is removed in such a manner that the edge value of each of the input pixels is held.

In the second aspect, preferably, in calculating the characteristic values, the edge value is converted into a contrast value by clipping the edge value.

In the second aspect, preferably, further comprising inputting various parameters, wherein

in performing the tone control, the tone control is performed based on the inputted various parameters, the contrast value, and the input pixel signal.

In the second aspect, preferably, in performing the tone control,

a tone curve is generated by applying a sigmoid function to the control parameters, and

the tone control is performed using the tone curve.

According to a third aspect of the present invention, there is provided a computer readable medium comprising a program for controlling brightness on image data, the program comprising:

calculating characteristic values of input pixels based on an input pixel signal; and

performing a tone control independently by each of the input pixels using control parameters corresponding to brightness of a peripheral pixel in vicinity of the corresponding input pixel based on each of the characteristic values.

In the third aspect, preferably, in calculating the characteristic values,

a first high-frequency component is removed from the input pixel signal to generate a first pixel signal,

a second high-frequency component is removed from the input pixel signal to generate a second pixel signal, and

a difference between the first pixel signal and the second pixel signal is calculated as an edge value.

### BRIEF DESCRIPTION OF THE DRAWINGS

FIG. 1 is graph illustrating a relationship between an input pixel and an output pixel in a conventional tone control.

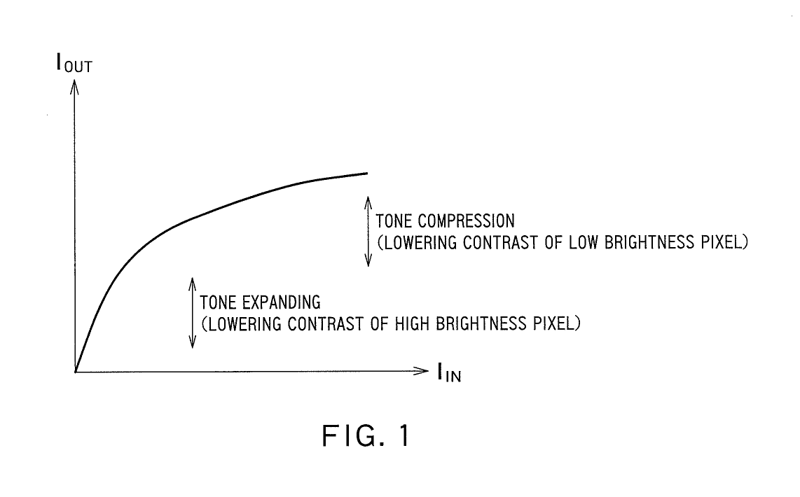

FIG. 2 is a block diagram illustrating a configuration of an image processing apparatus 10 according to an embodiment of the present invention.

FIG. 3 is a block diagram illustrating a configuration of an amount of a characteristic value calculator 16 in FIG. 2 of the image processing apparatus 10 according to the embodiment of the present invention.

FIG. 4 is a block diagram illustrating a configuration of a tone controller 18 in FIG. 2 of the image processing apparatus 10 according to the embodiment of the present invention.

FIG. 5 is a graph illustrating general curve characteristics extracted from a general standard sigmoid function for utilizing for the tone control process of the tone controller 18 in FIG. 2 of the image processing apparatus 10 according to the embodiment of the present invention.

FIG. 6 is a graph illustrating the general standard sigmoid function.

FIGS. 7A, 7B, 7C and 8 are graphs illustrating tone curves utilized used for a tone control process of the tone controller 18 in FIG. 2 of the image processing apparatus 10 according to the embodiment of the present invention.

### DETAILED DESCRIPTION OF THE INVENTION

Hereafter, embodiments according to the present invention will be described more specifically with reference to the drawings.

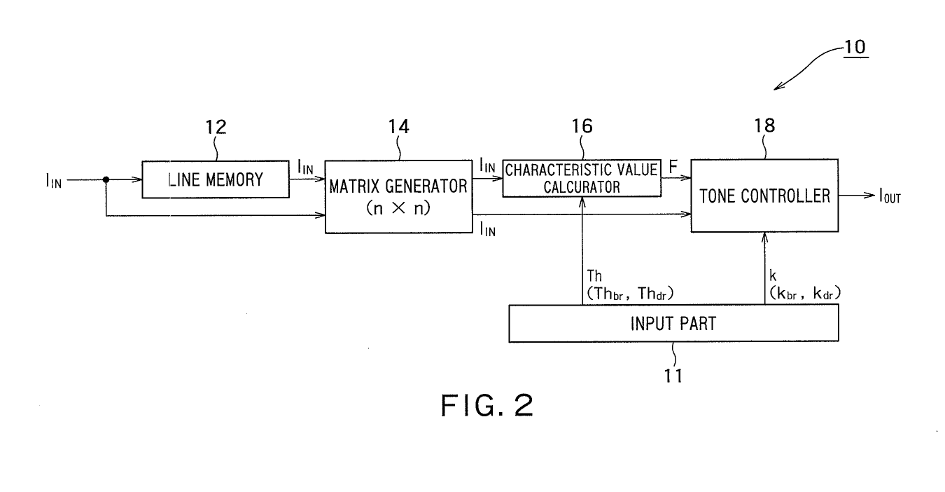

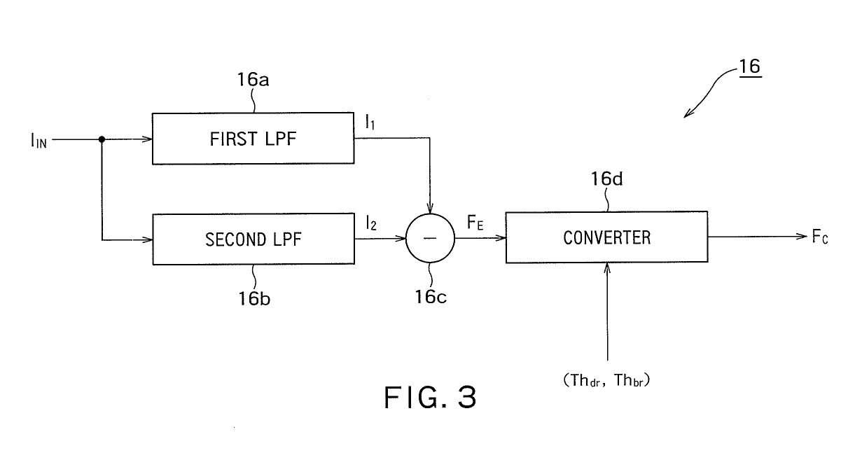

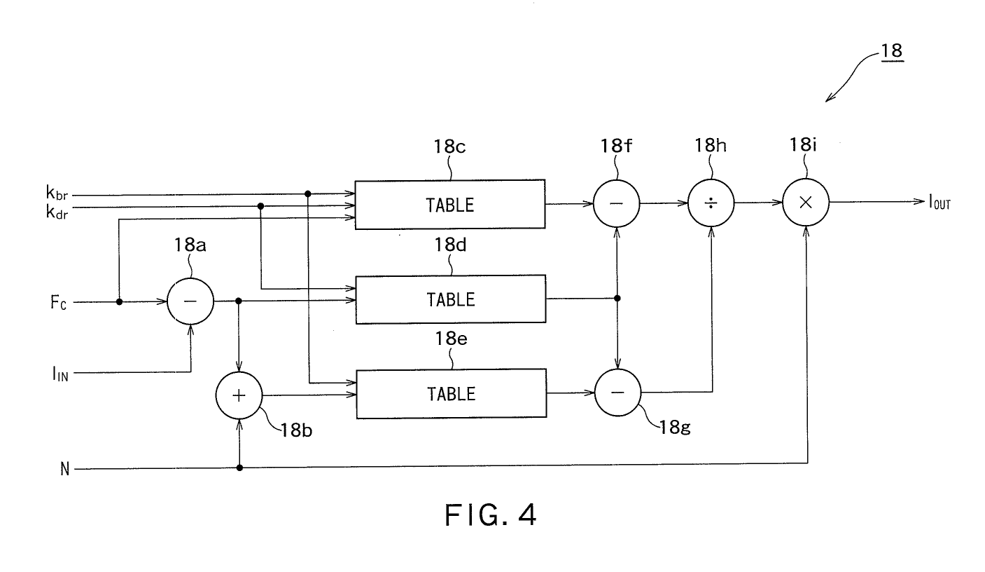

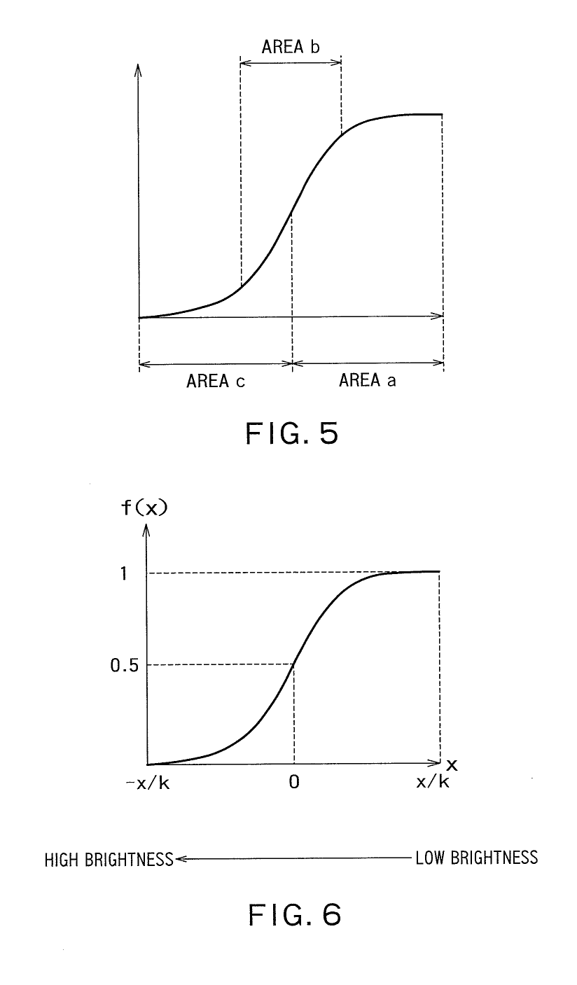

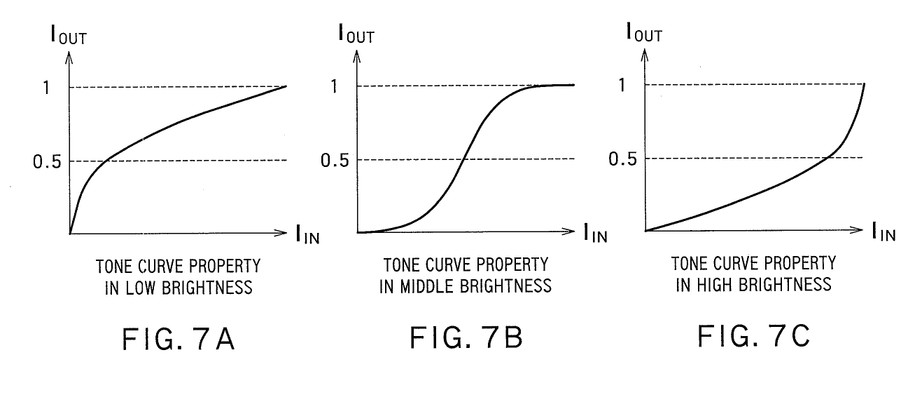

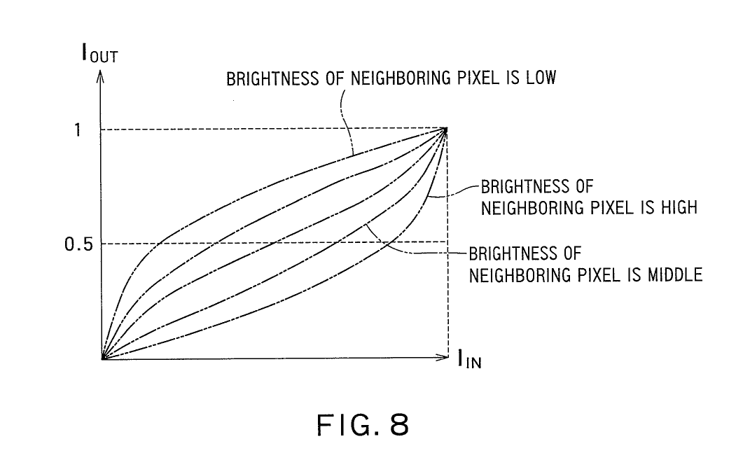

A configuration of an image processing apparatus according to an embodiment of the present invention will be described with reference to the drawings. FIG. 2 is a block diagram illustrating a configuration of an image processing apparatus 10 according to an embodiment of the present invention. FIG. 3 is a block diagram illustrating a configuration of a characteristic value calculator 16 in FIG. 2. FIG. 4 is a block diagram illustrating a configuration of a tone controller 18 in FIG. 2. FIG. 5 is a graph illustrating curve characteristics extracted from a standard sigmoid function. FIG. 6 is a graph illustrating the standard sigmoid function. FIGS. 7A, 7B, 7C and 8 are graphs illustrating tone curves used for a tone control of the tone controller 18 in FIG. 2.

The image processing apparatus 10 according to the embodiment is connected to a memory (not illustrated) capable of storing digitized image data (for example, YUV data and RGB data). As illustrated in FIG. 2, the image processing apparatus 10 includes an input part 11, a line memory 12, a matrix generator 14, a characteristic value calculator 16 and a tone controller 18.

The input part 11 in FIG. 2 is configured to input various parameters for image processing from the outside of the image processing apparatus 10. For example, when a user feeds a parameter from an input device such as a keyboard, the input part 11 inputs the parameter from the input device.

The line memory 12 in FIG. 2 is configured to store image data indicating an input pixel (hereinafter, called “input pixel signal”) I_{IN} for each predetermined number of lines. For example, the input pixel signal I_{IN} is the image data stored in the memory connected to the image processing apparatus 10 or the image data on an image stream. For example, an image data format is a Y signal, an RGB signal, a CMY signal or the like. Here, when the image data format is the RGB signal or the CMY signal, the image processing is performed for each color component (hereinafter, called “channel”). Further, when an image data array is an RGB Bayer array or a CMY mosaic array, the image processing is performed for each channel.

The matrix generator 14 in FIG. 2 is configured to generate a data array which is N×N matrix based on the input pixel signal I_{TN} stored in the line memory 12. As a value of the N is increased, a range of characteristics of a first low-pass filter (FIRST LPF) 16a and a second low-pass filter (SECOND LPF) 16b which are later mentioned is increased. In the embodiment, the value of N is preferably within a range between 3 and 7 in consideration of the load caused by processes of the first low-pass filter 16a and the second low-pass filter 16b, and a capacity of the memory.

The characteristic value calculator 16 in FIG. 2 is configured to calculate correlation (hereinafter, called “characteristic value”) between the input pixel and a peripheral pixel in vicinity of the corresponding input pixel from the data array generated by the matrix generator 14. That is, the characteristic value indicates the difference between the input pixel and the peripheral pixel.

As illustrated in FIG. 3, the characteristic value calculator 16 includes the first low-pass filter 16a, the second low-pass filter 16b, a subtractor 16c and a converter 16d.

The first low-pass filter 16a in FIG. 3 is configured to remove a predetermined high-frequency component (hereinafter, called “first high-frequency component”) from the input pixel signal I_{IN} to generate a first pixel signal I₁. A kernel of the first low-pass filter 16a is variable in accordance with a noise value in the parameter fed by the user or resolution thereof.

The second low-pass filter 16b in FIG. 3 is configured to remove a predetermined high-frequency component (hereinafter, called “second high-frequency component”) which is different from the first high-frequency component from the input pixel signal I_{IN} to generate a second pixel signal I₂. A kernel of the second low-pass filter 16b is variable in accordance with a noise value in the parameter fed by the user or the resolution thereof. It is preferable that the second low-pass filter 16b is an edge holding type filter such as a bilateral filter configured to hold an edge value of the input pixel. The edge holding type filter can perform high-speed calculation with a table indicating a relationship between a distance and a weight against a pixel difference, even in exponential calculation such as the edge holding type function (see equation 1). Further the edge holding type filter can generate the second pixel signal I₂ from which a high-frequency noise is removed.

$$\begin{matrix}[ Equation 1 ] & \\ g ( i , j ) = \frac{\begin{matrix}{\sum }_{n} {\sum }_{m} f ( i - m , j - n ) exp ( - \frac{{m}^{2} + {n}^{2}}{2 {σ}_{1}^{2}} ) \\ exp ( - \frac{{( f ( i , j ) - f ( i - m , j - n ) )}^{2}}{2 {σ}_{2}^{2}} )\end{matrix}}{\begin{matrix}{\sum }_{n} {\sum }_{m} exp ( - \frac{{m}^{2} + {n}^{2}}{2 {σ}_{1}^{2}} ) \\ exp ( - \frac{{( f ( i , j ) - f ( i - m , j - n ) )}^{2}}{2 {σ}_{2}^{2}} )\end{matrix}} & ( EQUATION 1 )\end{matrix}$$

The subtractor 16c in FIG. 3 is configured to calculate the difference between the first pixel signal I₁ generated by the first low-pass filter 16a and the second pixel signal I₂ generate by the second low-pass filter 16b. The calculated difference is the characteristic value F (i.e., edge value F_{E}) of the input pixel. The edge value F_{E} is the characteristic value F from which the noise is removed.

The converter 16d in FIG. 3 is configured to convert the edge value F_{E} calculated by the subtractor 16c into the characteristic value F of the input pixel (i.e., contrast value E_{C}) by clipping the edge value F_{E} using threshold values Th_{dr} and Th_{br}. The threshold values Th_{dr} and Th_{br} are for limiting the edge value F_{E} which is extremely large to an appropriate value. Specifically, the converter 16d converts the edge value F_{E} into the contrast value F_{C} using the threshold values Th_{dr} and Th_{br} in accordance with an algorithm indicated as equation 2. Here, the threshold values Th_{dr} and Th_{br} may be inputted by the input part 11 or may be calculated from a variable signal processed by a processor connected to the image processing apparatus 10, a histogram of an entire image or the like.

$$\begin{matrix}[ Equation 2 ] & \\ {F}_{C} = \{ \begin{matrix}+ Thbr & if ( Thbr > {F}_{E} ) \\ - Thdr & if ( - Thdr > {F}_{E} ) \\ {F}_{E} & else\end{matrix} & ( EQUATION 2 )\end{matrix}$$

The tone controller 18 in FIG. 2 is configured to generate an output pixel signal Iₒᵤₜ by performing the tone control independently by each of the input pixel signals using control parameters k (k_{br}, k_{dr}) corresponding to the brightness of the peripheral pixel based on the characteristic value (i.e., the contrast value F_{C} converted by the converter 16d in FIG. 3) of the input pixel. That is, the tone controller 18 performs the tone control in such a manner that the contrast in low brightness is increased in a low brightness area and the contrast in high brightness is increased in a high brightness area by dynamically generating an brightness control curve (hereinafter, called “tone curve”) based on the brightness of the peripheral pixel.

The tone controller 18 generates the output pixel signal I_{OUT} (see equation 5) by performing the tone control independently by each of the input pixel signals in accordance with the contrast value F_{C} using a function fₖ(x) (see equations 4.1 to 4.3) in which the parameter a in the sigmoid function (see equation 3) is converted into the control parameter k. Specifically, in order to prevent the contrast lowering in the case that the dynamic range is compressed, the tone controller 18 performs the tone control as follows. In the area where the average of the peripheral pixels is to be zero (i.e., the minimum value), the tone controller 18 performs the tone control using the tone curve (see FIG. 7A) having the same curve characteristic as the curve in the area a of the sigmoid function in FIG. 5. In the area where the average of the peripheral pixels is to be 128 (i.e., the middle value), the tone controller 18 performs the tone control using the tone curve (see FIG. 7B) having the same curve characteristic as the curve in the area b of the sigmoid function in FIG. 5. In the area where the average of the peripheral pixels is to be 255 (i.e., the maximum value), the tone controller 18 performs the tone control using the tone curve (see FIG. 7C) having the same curve characteristic as the curve in the area c of the sigmoid function in FIG. 5. As a result, the contrast of the input pixel is increased against the peripheral pixels.

$$\begin{matrix}[ Equation 3 ] & \\ {ς}_{a} ( x ) = \frac{1}{1 + exp ( - ax )} & ( EQUATION 3 ) \\ [ Equation 4 ] & \\ {f}_{k} ( x ) = \frac{1}{1 + exp ( - \frac{x}{k} )} & ( EQUATION 4.1 ) \\ {f}_{kbr} ( x ) = \frac{1}{1 + exp ( - \frac{x}{{k}_{br}} )} & ( EQUATION 4.2 ) \\ {f}_{kdr} ( x ) = \frac{1}{1 + exp ( - \frac{x}{{k}_{dr}} )} & ( EQUATION 4.3 ) \\ [ Equation 5 ] & \\ {I}_{out} = \frac{{f}_{k} ( {F}_{C} ) - {f}_{kdr} ( {F}_{C} - {I}_{in} )}{( {f}_{kbr} ( N + {F}_{C} - {I}_{in} ) - {f}_{kdr} ( {F}_{C} - {I}_{in} ) ) \times \frac{1}{N}} & ( EQUATION 5 )\end{matrix}$$

The tone controller 18 performs the tone control using a bright part control parameter k_{br} when the contrast value F_{C} is zero or larger (see equation 4.2). The tone controller 18 performs the tone control using a dark part control parameter k_{dr} when the contrast value F_{C} is smaller than zero (see equation 4.3). That is, the contrast can be emphasized while lowering the brightness level at a high brightness part by lowering the control parameter k_{br}. Further, the contrast can be emphasized while increasing the brightness level at a low brightness part by lowering the control parameter k_{dr}. In short, the effects of the dynamic range compression and the contrast emphasis can be enhanced by lowering both of the control parameters (k_{br}, k_{dr}). Further, the total brightness can be adjusted by changing the ratio (k_{br}:k_{dr}) between the control parameters.

The control parameter k in FIG. 2 is dynamically varies in accordance with the change of the brightness distribution in an arbitrary area of the input image. For example, the control parameter k dynamically varies in accordance with the input pixel having dynamically varying brightness distribution as moving image data. The control parameter k includes the bright part control parameter k_{br} corresponding to the function fₖ(x) brighter than the average of the peripheral pixels and the dark part control parameter k_{dr} corresponding to the function fₖ(x) darker than the average of the peripheral pixels. A gradient of the tone curve becomes small as the control parameter k becomes large and large as the control parameter k becomes small. The control parameter k may be inputted by the input part 11 or may be calculated from the variable signal processed by the processor connected to the image processing apparatus 10 or the histogram of the entire image or the like.

As illustrated in FIG. 4, the tone controller 18 includes subtractors 18a, 18f and 18g, an adder 18b, tables 18c to 18e, a divider 18h and a multiplier 18i as configurations to perform the calculation of equation 5.

The subtractor 18a in FIG. 4 is configured to calculate “F_{C}−I_{IN}” by performing a subtraction of the contrast value F_{C} and the input pixel signal I_{IN}.

The adder 18b in FIG. 4 is configured to calculate “N+F_{C}−I_{IN}” by performing an addition of the output of the subtractor 18a and a bit depth N. For example, the bit depth N is 255 when the input pixel signal I_{IN} includes 8 bits and is 1023 when the input pixel signal I_{IN} includes 10 bits.

The tables 18c to 18e in FIG. 4 are used for calculation of the sigmoid function. The tables 18c to 18e have the function fₖ(x) in a range from “−x” to “+x”. Table accuracy of the tables 18c to 18e is changed in accordance with the resolution of the input pixel signal I_{IN}. The table 18c is configured to calculate the function fₖ(F_{C}) on the contrast value F_{C} using the control parameters k (k_{br}, k_{dr}) (see equation 4.1). The table 18d is configured to calculate the function f_{kdr}(F_{C}−I_{IN}) on the output of the subtractor 18a using the dark part control parameter k_{dr} (see equation 4.2). The table 18e is configured to calculate the function f_{kbr}(N+F_{C}−I_{IN}) on the output of the adder 18b using the bright part control parameter k_{br} (see equation 4.3).

The subtractor 18f in FIG. 4 is configured to calculate “fₖ(F_{C})−f_{kdr}(F_{C}−I_{IN})” by performing a subtraction of the output of the table 18c and the output of the table 18d.

The subtractor 18g in FIG. 4 is configured to calculate “f_{kdr}(F_{C}−I_{IN})−f_{kbr}(N+F_{C}−I_{IN})” by performing a subtraction of the output of the table 18d and the output of the table 18e.

The divider 18h in FIG. 4 is configured to perform a division having the output of the subtractor 18f as a numerator and the output of the subtractor 18g as a denominator. That is, the divider 18h normalizes the outputs of the tables 18c to 18e.

The multiplier 18i in FIG. 4 is configured to generate an output pixel signal I_{OUT} by performing a multiplication of the outputs of the divider 18h and of the bit depth N. That is, the multiplier 18i performs bit depth adjustment on the outputs of the tables 18c to 18e normalized by the divider 18h.

In other words, the tone controller 18 performs the tone control using the tone curve for each input pixel. As illustrated in FIG. 6, the tone curve obtained from the sigmoid function has an S-shaped characteristic having center at zero. The tone controller 18 extracts an arbitrary range from the tone curve in FIG. 6 to generate the tone curve for each input pixel in accordance with the brightness of peripheral pixels (see FIGS. 7A to 7c). This is for performing the optimal tone control to improve an image quality through the histogram of the entire image taking account of that the tone control degree of brightness balance of the entire image in the low brightness part is different from that in the high brightness part. For example, since the tone curve in FIG. 7A has characteristics to wholly increase pixel values and to emphasize contrast in a low brightness area, it is selected as the tone curve for the low brightness area. Since the tone curve in FIG. 7B has characteristics to compress contrasts in the low brightness area and a high brightness area and to emphasize contrast in an intermediate brightness area, it is selected as the tone curve for the intermediate brightness area. Since the tone curve in FIG. 7C has characteristics to wholly decrease the pixel values and to emphasize contrast in the high brightness area, it is selected as the tone curve for the high brightness area. Consequently, the brightness of the output pixel is increased against that of the input pixel when the peripheral pixels are at low brightness. The brightness of the output pixel is substantially held when the peripheral pixels are at intermediate brightness. The brightness of the output pixel is lowered against that of the input pixel when the peripheral pixels are at high brightness. Accordingly, a controlled image (i.e., the output pixels) has contrast at edge parts, which is held against the input pixels.

Ordinarily, when the tone control is performed on all image pixels using a common tone curve, the contrast at the edge parts of the output pixels is lowered. However, since the tone controller 18 performs the tone control using the tone curve in accordance with peripheral brightness (see FIG. 8), the contrast is locally increased in an area where tone is compressed in the tone control. Thereby, the contrast lowering at the edge parts of the output pixels can be prevented.

Here, in the embodiment of the present invention, the converter 16d may be omitted. In this case, the tone controller 18 performs the tone control using the edge value F_{E} as the characteristic value F.

According to the embodiment, the output pixels are generated while compressing the dynamic range and holding contrast against the input pixels accumulated in the imaging element or stored in the memory. As a result, a clear image having appropriate brightness can be obtained over a wide brightness range as a human retina which changes visual sensitivity against local brightness of an image has the wide brightness range.

Further, according to the embodiment, the first low-pass filter 16a and the second low-pass filter 16b may be configured to remove different high-frequency components against the input pixel signal I_{IN} from each other, respectively. In particular, the second low-pass filter 16b may be an edge holding type filter. Accordingly, high-frequency noise is removed from the input pixel signal I_{IN}. As a result, unnatural increase of the contrast against an edge can be prevented and an image having further natural contrast can be obtained.

Further, according to the embodiment, the converter 16d may be configured to convert the edge value F_{E} into the contrast value F_{C} and the tone controller 18 may be configured to use the contrast value F_{C} as the characteristic value F. Accordingly, divergence between the input pixel and the peripheral pixels can be reduced compared to the case that the edge value F_{E} is used as the characteristic value F by the tone controller 18.

Further, according to the embodiment, the input part 11 may input parameter fed by the user and the tone controller 18 may perform the tone control using the parameters. Accordingly, the tone control desired by the user can be performed. For example, when the user sets a shot scene, an appropriate tone control can be performed in accordance with the shot scene set by the user.

Further, according to the embodiment, the tone controller 18 may generate the tone curve using the sigmoid function. Accordingly, the tone control using a more appropriate tone curve can be performed.

For example, when the image processing apparatus 10 is mounted on an existing camera system such as a digital camera, a dynamic range thereof can be improved. The image processing apparatus 10 can provide the similar effect to a camera system such as a monitoring camera and an on-vehicle camera which requires a wide dynamic range.

Further, when the image processing apparatus 10 is mounted on a camera such as a web-camera and a picturephone camera, which is connected to a computer, an appropriate control can be performed on a face image even in a backlight condition. That is, the control is performed so as to clarify the image.

At least a portion of the image processing apparatus 10 according to the above-described embodiments of the present invention may be composed of hardware or software. When at least a portion of the image processing apparatus 10 is composed of software, a program for executing at least some functions of the image processing apparatus 10 may be stored in a recording medium, such as a flexible disk or a CD-ROM, and a computer may read to execute the program. The recording medium is not limited to a removable recording medium, such as a magnetic disk or an optical disk, but it may be a fixed recording medium, such as a hard disk or a memory.

In particular, in the case that the characteristic value calculator 16 and the tone controller 18 of the image processing apparatus 10 are composed of software, the function to convert an image stored in a memory into an image having a wide dynamic range can be installed on a software application for retouching, developing or the like.

In addition, the program for executing at least some functions of the image processing apparatus 10 according to the above-described embodiment of the present invention may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

The above-described embodiments of the present invention are just illustrative, but the invention is not limited thereto. The technical scope of the invention is defined by the appended claims, and various changes and modifications of the invention can be made within the scope and meaning equivalent to the claims.

What is claimed is:

1. An image processing apparatus comprising:
a characteristic value calculator configured to calculate characteristic values of input pixels based on an input pixel signal; and
a tone controller configured to perform a tone control independently by each of the input pixels using control parameters corresponding to brightness of a peripheral pixel in vicinity of the corresponding input pixel based on each of the characteristic values calculated by the characteristic value calculator.

2. The apparatus of claim 1, wherein the characteristic value calculator comprises:
a first low-pass filter configured to remove a first high-frequency component from the input pixel signal to generate a first pixel signal;
a second low-pass filter configured to remove a second high-frequency component from the input pixel signal to generate a second pixel signal; and
a subtractor configured to calculate a difference between the first pixel signal generated by the first low-pass filter and the second pixel signal generated by the second low-pass filter as an edge value.

3. The apparatus of claim 2, wherein the second low-pass filter removes the second high-frequency component in such a manner that the edge value of each of the input pixels is held.

4. The apparatus of claim 2, wherein the characteristic value calculator further comprises a converter configured to convert the edge value calculated by the subtractor into a contrast value by clipping the edge value.

5. The apparatus of claim 4, further comprising an input part configured to input various parameters, wherein
the tone controller performs the tone control based on the inputted various parameters, the contrast value converted by the converter, and the input pixel signal.

6. The apparatus of claim 5, wherein the tone controller generates a tone curve by applying a sigmoid function to the control parameters and performs the tone control using the tone curve.

7. The apparatus of claim 3, wherein the characteristic value calculator further comprises a converter configured to convert the edge value calculated by the subtractor into a contrast value by clipping the edge value.

8. The apparatus of claim 7, further comprising an input part configured to input various parameters, wherein
the tone controller performs the tone control based on the inputted various parameters, the contrast value converted by the converter, and the input pixel signal.

9. The apparatus of claim 8, wherein the tone controller generates a tone curve by applying a sigmoid function to the control parameters and performs the tone control using the tone curve.

10. An image processing method comprising:
calculating characteristic values of input pixels based on an input pixel signal; and
performing a tone control independently by each of the input pixels using control parameters corresponding to brightness of a peripheral pixel in vicinity of the corresponding input pixel based on each of the characteristic values.

11. The method of claim 10, wherein in calculating the characteristic values,
a first high-frequency component is removed from the input pixel signal to generate a first pixel signal,
a second high-frequency component is removed from the input pixel signal to generate a second pixel signal, and
a difference between the first pixel signal and the second pixel signal is calculated as an edge value.

12. The method of claim 11, wherein in removing the second high-frequency component, the second high-frequency component is removed in such a manner that the edge value of each of the input pixels is held.

13. The method of claim 11, wherein in calculating the characteristic values, the edge value is converted into a contrast value by clipping the edge value.

14. The method of claim 13, further comprising inputting various parameters, wherein
in performing the tone control, the tone control is performed based on the inputted various parameters, the contrast value, and the input pixel signal.

15. The method of claim 14, wherein in performing the tone control,
a tone curve is generated by applying a sigmoid function to the control parameters, and
the tone control is performed using the tone curve.

16. The method of claim 12, wherein in calculating the characteristic values, the edge value is converted into a contrast value by clipping the edge value.

17. The method of claim 16, further comprising inputting various parameters, wherein
in performing the tone control, the tone control is performed based on the inputted various parameters, the contrast value, and the input pixel signal.

18. The method of claim 17, wherein in performing the tone control,
a tone curve is generated by applying a sigmoid function to the control parameters, and
the tone control is performed using the tone curve.

19. A computer readable medium comprising a program for controlling brightness on image data, the program comprising:
calculating characteristic values of input pixels based on an input pixel signal; and
performing a tone control independently by each of the input pixels using control parameters corresponding to brightness of a peripheral pixel in vicinity of the corresponding input pixel based on each of the characteristic values.

20. The program of claim 19, wherein in calculating the characteristic values,
a first high-frequency component is removed from the input pixel signal to generate a first pixel signal,
a second high-frequency component is removed from the input pixel signal to generate a second pixel signal, and
a difference between the first pixel signal and the second pixel signal is calculated as an edge value.
